(19) United States
(12) Patent Application Publication
(10) Pub. No.: US 2024/0019554 A1
(43) Pub. Date: Jan. 18, 2024

(54) CONTROL METHOD AND DEVICE FOR MULTICHANNERL LASER EMISSION, AND COMPUTER READABLE STORAGE MEDIUM

(71) Applicant: SUTENG INNOVATION TECHNOLOGY CO., LTD., Shenzhen (CN)

(72) Inventor: Shen JIANG, Shenzhen (CN)

(73) Assignee: SUTENG INNOVATION TECHNOLOGY CO., LTD., Shenzhen (CN)

(21) Appl. No.: 18/219,702

(22) Filed: Jul. 9, 2023

(30) Foreign Application Priority Data
Jul. 15, 2022 (CN) 202210833777.0

(51) Int. Cl. G01S 7/484

(52) U.S. Cl. CPC G01S 7/484

(57) ABSTRACT

A control method and device for multichannel laser emission, and a computer readable storage medium are disclosed. The method includes: controlling the emission of secondary emergent lasers of a plurality of channels of a multichannel LiDAR in a time-sharing manner during an operation cycle of the multichannel LiDAR; and emitting a primary emergent laser at a preset reference moment of each channel or encoding and modulating the emission of the primary emergent laser according to the detection result of the secondary emergent lasers of the plurality of channels.

### CROSS-REFERENCE TO RELATED APPLICATION

The present application claims the benefit of priority to Chinese Patent Application No. 202210833777.0, filed on Jul. 15, 2022, which is hereby incorporated by reference in its entirety.

### TECHNICAL FIELD

The present application relates to the field of LiDAR, and in particular, to a control method and device for multichannel laser emission, and a computer readable storage medium.

### BACKGROUND

A LiDAR consists of an emitting system, a receiving system, a scanning control system, and a data processing system. The LiDAR measures a distance by measuring a time difference between an emergent detection laser and a received echo laser, and has the advantages of high resolution, high sensitivity, strong anti-interference ability, and being independent of lighting conditions, etc. The LiDAR has been widely used in the fields of autonomous driving, logistics vehicles, robots, vehicle-road coordination, and public intelligent transportation.

Multichannel LiDARs can scan a plurality of channels simultaneously, can extend a field of view, and are currently widely used in LiDAR products. Due to the simultaneous emission and reception of multiple channels in a multichannel LiDAR, crosstalk occurs between channels, resulting in spurious images that can cause detection errors. The related art solves the crosstalk during the emission of multichannel LiDARs by using physical optical isolation. However, the physical optical isolation requires additional hardware or changes to the structure of the LiDAR products, leading to increased costs.

### SUMMARY

The present application provides a control method and device for the multichannel laser emission, and a computer readable storage medium, which prevents crosstalk between the channels during detection without increasing firmware cost.

A first aspect of the present application provides a control method for the multichannel laser emission, including:
controlling the emission of secondary emergent lasers of a plurality of channels of the multichannel LiDAR in a time-sharing manner during an operation cycle of the multichannel LiDAR;
emitting a primary emergent laser at a preset reference moment of the channel or encoding and modulating the emission of the primary emergent laser according to the detection result of the secondary emergent lasers of the plurality of channels.

A second aspect of the present application provides a device for controlling multichannel laser emission, including:
a first control module, configured to control the emission of secondary emergent lasers of a plurality of channels of the multichannel LiDAR in a time-sharing manner during an operating cycle of the multichannel LiDAR; and
a second control module, configured to emit a primary emergent laser at a preset reference moment of the channel or encode and modulate emission of the primary emergent laser according to a detection result of the secondary emergent lasers of the plurality of channels.

A third aspect of the present application provides an electronic apparatus, including:
a processor; and
a storage having executable codes stored thereon, where when executed by the processor, the executable codes cause the processor to execute the method as described above.

A fourth aspect of the present application provides a computer readable storage medium having executable codes stored thereon. When executed by a processor of an electronic apparatus, the executable codes cause the processor to execute the method as described above.

Based on the technical solution provided by the present application, the emission of secondary emergent lasers of a plurality of channels of a multichannel LiDAR is controlled in a time-sharing manner during an operation cycle of the multichannel LiDAR A primary emergent laser is emitted at the preset reference moment of the channel or the emission of the primary emergent laser is encoded and modulated according to the detection result of the secondary emergent lasers of the plurality of channels. The detection cycle of each of the channels of the LiDAR includes a secondary emission cycle and a primary emission cycle. The LiDAR of the plurality of channels includes the plurality of secondary emission and primary emission cycles. The duration of the operation cycle of the LiDAR is limited by the frame rate of a system. The emission of the secondary emergent lasers of the plurality of channels is controlled in a time-sharing manner. The primary emergent laser is emitted at the preset reference moment of the channel, or the emission of the primary emergent laser is encoded and modulated. Therefore, the secondary emission and primary emission cycles of the plurality of channels can be spaced apart in time, or a reflection laser of this channel can be identified by encoding and decoding, which can prevent crosstalk between the channels during the operation of the multichannel laser without increasing the cost.

It should be understood that the above general descriptions and the following detailed descriptions are only exemplary and explanatory and impose no limitation on the present application.

### BRIEF DESCRIPTION OF DRAWINGS

Exemplary embodiments of the present application are described with reference to the accompanying drawings, to illustrate the above and other objectives, features, and advantages of the present application. In the exemplary embodiments of the present application, the same reference numerals represent the same components.

FIG. 1a is a schematic structural diagram of a multichannel LiDAR provided in an embodiment of the present application;

FIG. 1b is a schematic diagram of splicing the field of view formed by channels of a five-channel LiDAR provided in an embodiment of the present application;

FIG. 2 is a flowchart of a control method for the multichannel laser emission provided in an embodiment of the present application;

FIG. 3a is a schematic diagram of the timing of the emission of a primary emergent laser provided in the present application when all five channels of a LiDAR adopt a near-range operation mode;

FIG. 3b is a schematic diagram of the timing of the emission of a primary emergent laser provided in the present application when five channels of a LiDAR partially adopt a near-range operation mode and partially adopt a long-range operation mode;

FIG. 4 is a schematic structural diagram of a control device for the multichannel laser emission provided in an embodiment of the present application; and

FIG. 5 is a schematic structural diagram of an electronic apparatus provided in an embodiment of the present application.

### DETAILED DESCRIPTION

The following describes embodiments of the present application with reference to the accompanying drawings. Although the embodiments of the present application are shown in the accompanying drawings, it should be understood that the present application can be implemented in various forms and should not be limited by the embodiments illustrated herein. On the contrary, the embodiments are provided for better understanding of the present application and delivery of the complete scope of the present application to a person skilled in the art.

The terms used in the embodiments of the present application are merely for the purpose of illustrating embodiments, but are not intended to limit the present application. The singular forms of “a,” “the,” and “this” as used in the present application and the appended claims are also intended to include plural forms, unless the context clearly indicates otherwise. It should be further understood that the term “and/or” used in this specification refers to any combination of one or more of the associated items listed and all combinations thereof.

It should be understood that although the terms “first,” “second,” “third,” and the like are used to describe various types of information in the present application, the information should not be limited to these terms. The terms are only used to distinguish between information of the same type. For example, without departing from the scope of the present application, first information can also be referred to as second information, and similarly, second information can also be referred to as first information. Therefore, a feature with a determiner such as “first” or “second” can expressly or implicitly include one or more features. In the description of the present application, “a plurality of” means two or more, unless otherwise specifically defined.

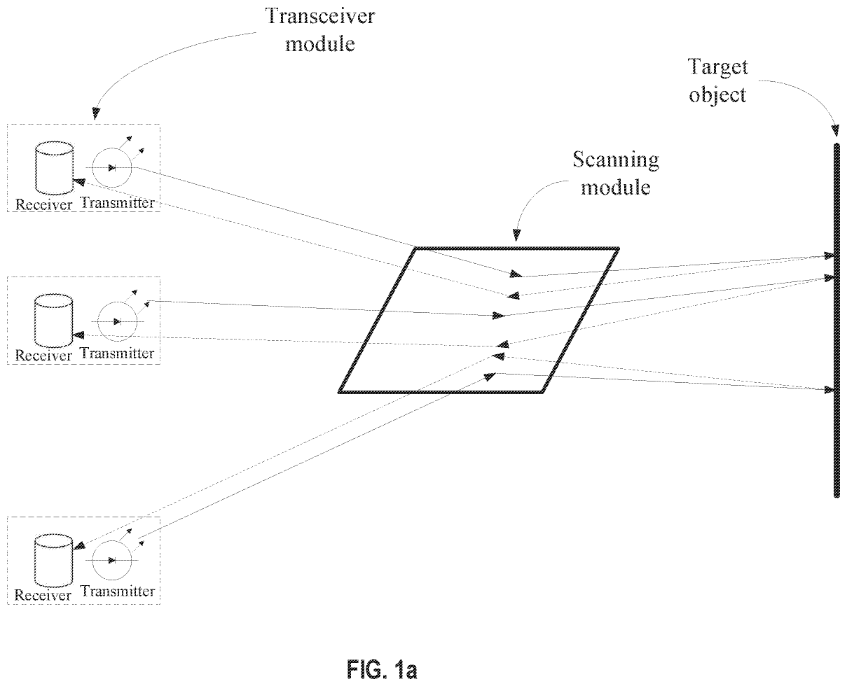

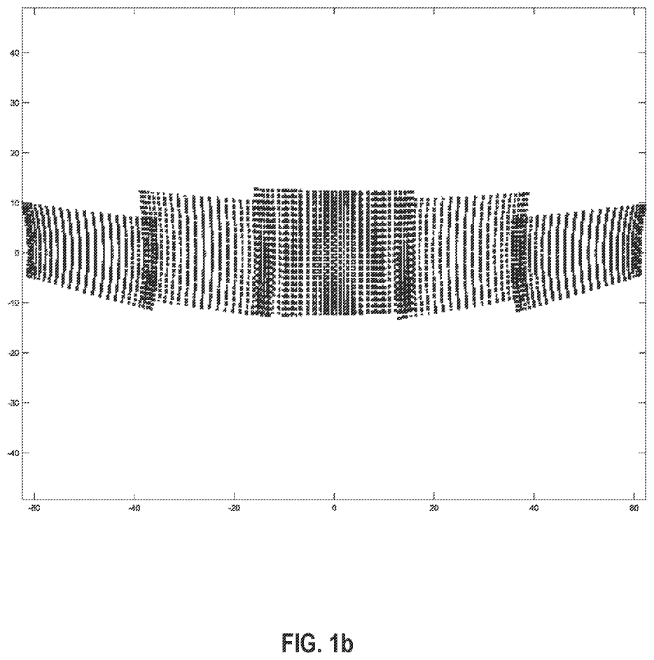

A multichannel LiDAR can scan a plurality of channels simultaneously, extend a field of view of the LiDAR, and is currently widely used in LiDAR products. Taking multichannel LiDAR scanning with MEMS (Micro-Electro-Mechanical System) as an example, as shown in FIG. 1a, the multichannel LiDAR includes a transceiver module and a scanning module. The scanning module adopts a MEMS galvanometer. An emitter of the transceiver module emits an emergent laser (shown as a straight solid line with an arrow in the figure), which emits to a scanning module. The MEMS galvanometer of the scanning module moves to achieve scanning and covers the whole field of view. The emergent laser is reflected by an object and returns to a reflection laser (as shown by a straight dashed line with an arrow in the figure). Optical paths of the reflection laser and the emergent laser are coaxial. The reflection laser returns via a path of the scanning module—the transceiver module and is received by a receiver in the transceiver module. Due to the limited deflection angle of the MEMS galvanometer, an optical path of one transceiver module covers a smaller field of view after passing through the scanning module. To expand the field of view of the LiDAR, the plurality of transceiver modules are arranged to share one MEMS galvanometer for scanning, forming the effect of the splicing of the plurality of fields of view. FIG. 1b shows a schematic diagram of the splicing of the field of view formed by the channels of the LiDAR containing the five channels. In this way, each of the transceiver modules is one channel of the LiDAR. Light rays (the emergent and reflection lasers) between the plurality of channels are isolated from each other.

On the one hand, because the frame rate of a system determines the limited duration of a detection cycle, and the duration of an analysis region (including primary emission and secondary emission analysis regions) of each of the channels is also related to the ranging capability of the system and thus the duration of the detection cycle is fixed. Therefore, if the analysis regions of different channels overlap in time, this leads to a crosstalk between optical paths of each of the channels, i.e., each of the channels may receive the reflection laser that does not correspond to the channel. On the other hand, when emitting the emergent laser, the multichannel LiDAR adopts drive solutions of charging energy, transferring energy, and enabling energy. Timing and sequencing control becomes more difficult because charging and transferring energy take a period of time. If there is no any better timing control solution, crosstalk between the channels is also caused. The related art solves crosstalk between the plurality of channels by physical optical isolation. However, physical optical isolation requires additional hardware or changes in the structure of the LiDAR product, which means an increase in costs.

In response to the above problems, an embodiment of the present application provides a control method for the multichannel laser emission, which can prevent crosstalk between channels durig detection without increasing firmware cost.

The technical solutions of embodiments of the present application are described in detail below in conjunction with the drawings.

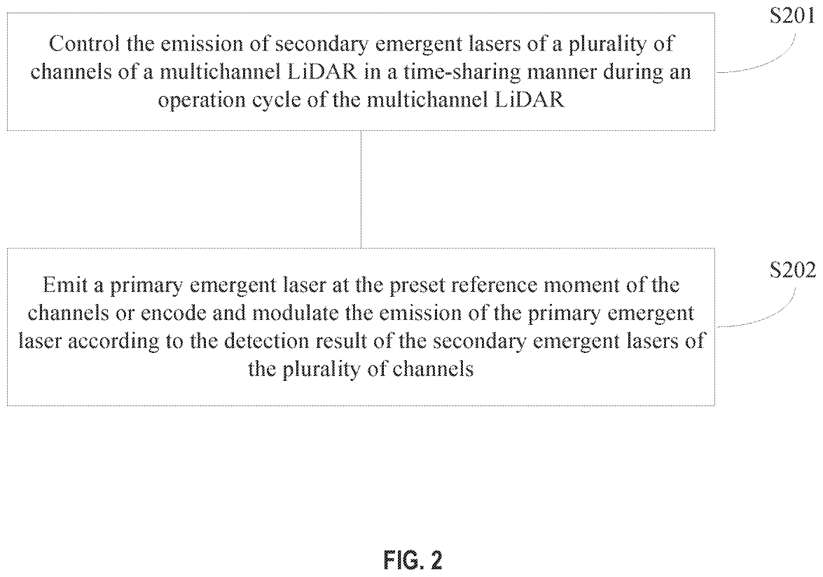

FIG. 2 shows a flowchart of a method for controlling the multichannel laser emission shown in an embodiment of the present application. The method includes steps S201 to S202, which are illustrated as follows.

Step S201: controlling the emission of secondary emergent lasers of a plurality of channels of a multichannel LiDAR in a time-sharing manner during an operation cycle of the multichannel LiDAR

Because the multichannel LiDAR scans through the plurality of channels to complete one detection task, a process which the plurality of channels of the multichannel LiDAR complete one detection task can be defined as one operation cycle of the multichannel LiDAR. For example, it is assumed that the multichannel LiDAR has five channels CH1-CH5, a period of time from the same preset moment (for example, the preset moment can be the moment of the generation of initial signals of the galvanometer or the moment when it is generated by an internal clock of the multichannel LiDAR) of the five channels CH1-CH5 to the end of the completion of one detection task can be called as one operation cycle of the multichannel LiDAR

Regarding each of the channels of the multichannel LiDAR, the detection cycle includes a secondary emission cycle and a primary emission cycle. A secondary emergent laser is emitted, and a corresponding reflection laser is received during the secondary emission cycle. A primary emergent laser is also emitted, and a corresponding reflection laser is received during the primary emission cycle. The detection result of the secondary emission cycle and the detection result of the primary emission cycle are spliced together to obtain one detection result covering a full-ranging scope. When a laser device emits an emergent laser, ranging begins. Then, a receiver is turned on in an operation state until the duration of time of an analysis region is passed, at which time the receiver is turned off. The duration of the analysis region is greater than or equal to the flight time of emergent laser photons to and back from the farthest detection distance to ensure that photons returned from the farthest detection distance can be received. The higher the emission power of the emergent laser, the greater the farthest detection distance, and the longer the corresponding analysis region. As mentioned before, the output power of the secondary emergent laser is lower, and a secondary emission analysis region is shorter. The secondary emergent laser of each of the channels has the same emergent power. The duration of the secondary emission analysis region for each of the channels is a second preset time.

As one embodiment of the present application, the emission of the secondary emergent lasers of the plurality of channels of the multichannel LiDAR is controlled in the time-sharing manner, which can be used to sequentially control the secondary emergent lasers of the plurality of channels to emit at intervals of a first preset time. Taking the above multichannel LiDAR with the five channels CH1-CH5 as an example, a secondary emergent laser of CH1 emits at moment T1. A secondary emergent laser of CH2 emits at moment T2, and so on, and a secondary emergent laser of CH5 emits at moment T5. The interval of the emission moment of the secondary emergent laser of the adjacent channel is the first preset time, i.e., the interval between T1 and T2 is the first preset time; the interval between T2 and T3 is the first preset time; the interval between T3 and T4 is the first preset time, and the interval between T4 and T5 is the first preset time.

The first preset time is greater than or equal to the second preset time. If the second preset time is greater than the first preset time, the secondary emission analysis regions of different channels overlap in time. When the receiver of the previous channel (e.g., CH1) still works, the secondary emergent laser of the next channel (e.g., CH2) begins to emit. At this time, the reflection laser received by a receiver of CH1 can be a reflection laser corresponding to the secondary emergent laser of CH1 or a reflection laser corresponding to the secondary emergent laser of CH2. However, the receiver of CH1 cannot distinguish which channel the received reflection laser corresponds to the emergent laser, so a crosstalk between the CH1 and CH2 occurs. Therefore, the first preset time is greater than or equal to the second preset time. Otherwise, conditions for crosstalk between the channels can be created, which increases the probability of the crosstalk between the channels.

The secondary emergent lasers of the plurality of channels are emitted sequentially. A secondary emission detection cycle occupies 5 times the first preset time. As can be seen from the foregoing, the multichannel LiDAR has a limited duration of the operation cycle. The minimum of the first preset time can be equal to the second preset time. The second preset time, i.e., the duration of the secondary emission analysis region, is related to the output power of the secondary emergent laser. Thus, in a case where the system parameters of the multichannel LiDAR are determined, the second preset time is a known and fixed amount.

Because the secondary emission analysis region is shorter, the time of five secondary emission detection cycles does not occupy much time in the working cycle of the multichannel LiDAR. Therefore, the emission of the secondary emergent lasers of the plurality of channels can be controlled in the time-sharing manner, thereby avoiding crosstalk between the plurality of channels during the secondary emission detection cycle.

In an optical path of the LiDAR, a small portion of the energy of the emergent laser emitted by the laser device passes through directly a stray path (i.e., a stray light) and reaches the receiver. An echo laser received by the receiver includes a reflection laser returned from the reflection of the stray light and the emergent laser. After receiving the stray light, the receiver excites a certain number of single photon units and outputs photocurrent signals, i.e., leading signals. A true reflection laser returned from a target object at a close distance reaches the receiver faster. The photocurrent signals (reflection signals) of the true reflection laser are superimposed on the leading signals and cannot be identified, resulting in detection failure. In practice, the higher the power of the emergent light, the greater the energy of the stray light, and the longer the extinction time of the leading signals. The stray light directly leads to early saturation of the receiver, which is unable to respond to the reflection laser detected at the close distance, thus creating a near-field blind region in the LiDAR. The primary emission and secondary emergent laser have different emission powers, and both correspond to different ranging scopes and near-field blind regions. In the same detection cycle, the detection result of the primary emergent laser and the detection result of the secondary emergent laser are spliced together and fused to obtain point cloud data for the whole ranging scope. For example, the secondary emission detection cycle detects 0-20 m near-field regions to obtain a secondary emission detection result. If the primary emergent laser adopts a long-range operation mode, a primary emission detection cycle detects 15-200 m far-range regions to obtain a primary emission detection result. Two sets of the detection result are spliced together and fused to obtain point cloud data covering 0 to 200 m, thus eliminating a near-field blind region of laser detection.

In some embodiments, controlling the emission of the secondary emergent lasers of the plurality of channels by the interval of the first preset time can be as follows: at a first moment, controlling each of the plurality of channels to start secondary emission charging energy; after the secondary emission charging energy, starting secondary emission transferring energy of each of the channels; after the secondary emission transferring energy of each of the channels, controlling each of the channels sequentially to start secondary emission enabling energy. The channel emits the secondary emergent laser. An interval of the secondary emission enabling energy of the adjacent channel is the first preset time.

It should be noted that the driving method of the LiDAR can be a constant-voltage source direct drive. The advantage of this driving solution is that it directly drives the emission of laser beam, and is capable of quickly responding and adjusting the power of the emergent light, but the disadvantage is that a constant-voltage source requires higher power and therefore costs and power consumption are larger. When the LiDAR adopts a constant-voltage source direct-drive laser device, controlling the emission of the secondary emergent lasers of the plurality of channels by the interval of the first preset time can be as follows: at the moment of the emission of the secondary emergent laser of each of the channels, control instructions are sent to a drive circuit. After receiving the control instructions, the drive circuit turns on a constant-voltage source so that the laser device emits the secondary emergent laser. In some embodiments, at moment T1, the drive instructions are sent to a drive circuit of CH1 to turn on the constant-voltage source. The laser device emits the secondary emergent laser. At the interval of the first preset time, the drive instructions are sent to the drive circuit of CH1 to turn on the constant-voltage source at moment T2; the laser device emits the secondary emergent laser; and so on until a laser device of CH5 emits the secondary emergent laser at the moment of T5. Drive circuits of the plurality of channels can be shared, or each of the channels can be provided with a corresponding drive circuit.

Another drive solution for the LiDAR is to adopt charging energy, transferring energy, and enabling energy. A charging energy phase includes charging one energy storage element for a power source, and storing electrical energy in the energy storage element. A transferring energy phase includes transferring the electrical energy stored on the energy storage element to a transferring energy element. The enabling energy phase includes releasing the electrical energy stored on the transferring energy element to drive the laser device to emit a laser beam after the transfer of the electrical energy is completed. Because both the charging energy and the transferring energy take up a certain amount of time, the charging energy, transferring energy, and enabling energy of the drive circuit have strict timing requirements to ensure the frame rate of laser point cloud data, as explained below.

(1) The charging energy and the transferring energy are continuous in timing. i.e., after the charging energy, it enters the phase of transferring energy immediately. In some embodiments, the drive circuit receives the start instructions of charging energy to start to emit the charging energy, and then receives the ending instructions to end the charging energy while the transferring energy starts.

(2) After the transferring energy is completed, the enabling energy can begin. In some embodiments, when enabling energy signals are received, the enabling energy begins.

(3) All the electrical energy stored on the energy transfer element is released at one time during the enabling energy. One transferring energy corresponds to one enabling energy.

(4) During the charging energy process of the power source charging the energy storage element, the enabling energy can also be conducted.

The above first moment can be the moment after the end of the maximum encoding enabling energy of the primary emergent laser in the previous operation cycle. The detection cycle includes the secondary emission detection cycle and the primary emission detection cycle. When the primary emergent laser adopts the long-range mode of the operation, modulation is conducted with coding, i.e., random time is added before the primary emergent laser starts the charging energy. The maximum encoding is the duration of the maximum random time set aside. After the maximum encoding enabling energy of the primary emergent laser that the first moment is arranged on the previous operation cycle, and after the enabling energy of the previous operation cycle of all the channels, the secondary emission charging energy and the secondary emission transferring energy of all the channels of the current cycle then start. All the channels have the same moment of the secondary emission charging energy and the secondary emission transferring energy, thereby simplifying a control logic. In some embodiments, the first moment can be the moment after a period of the preset time when the maximum encoding enabling energy of the primary emergent laser of the previous operation cycle ends. This preset time can be set according to practical needs, for example, 6 ns-13 ns. The longer the charging time, the more electrical energy stored on the energy storage element, and the greater the power of the emergent light. When the emission power of the secondary emergent laser is determined, the charging energy time of the secondary emergent laser is also determined. The transferring energy field of view should exceed a preset lower time limit to ensure that all the electrical energy stored on the energy storage element can be transferred to the transferring energy element. Regarding the multichannel LiDAR, the frame rate of the system determines the limited duration of the detection cycle, and the duration of the analysis region (including the primary emission analysis region and the secondary emission analysis region) of each of the channels is also related to the ranging capability of the system and thus the duration of the detection cycle is fixed. Therefore, if the secondary emission analysis regions of different channels overlap in time, a crosstalk between optical paths of each of the channels is caused, i.e., each of the channels can receive the reflection laser that does not correspond to the channel. Therefore, the emission of the secondary emergent lasers of the plurality of channels of the multichannel LiDAR is controlled in a time-sharing manner during the operation cycle of the multichannel LiDAR, so that the secondary emergent lasers of the plurality of channels emit sequentially to avoid the crosstalk.

Step S202: emitting the primary emergent laser at the preset reference moment of the channel or encoding and modulating the emission of the primary emergent laser according to the detection result of the secondary emergent lasers of the plurality of channels.

As can be seen from the preceding, the detection cycle of each of the channels includes the secondary emission detection cycle and the primary emission detection cycle. Based on the detection result of the secondary emergent laser, the operation mode of the primary emergent laser is determined. The operation mode of the primary emergent laser includes a near-range operation mode and a long-range operation mode. The two operation modes have different emission power and the different duration of the corresponding analysis region. Therefore, different emission timing controls are adopted so that the plurality of channels complete one detection cycle within the operation cycle of the LiDAR.

As an embodiment of the present application, the steps of emitting the primary emergent laser at the preset reference moment of the channel or encoding and modulating the emission of the primary emergent laser according to the detection result of the secondary emergent lasers of the plurality of channels can be as follows: determining the operation mode of the primary emergent laser of the corresponding channel according to the detection result of the plurality of secondary emergent laser, obtaining the operation mode of the primary emergent laser of all the channels; if the primary emergent lasers of the channel adopts the near-range mode of the operation, the primary emergent laser is emitted at the preset reference moment of the channels; if the primary emergent laser of the channel adopts the long-range mode of the operation, the emission of the primary emergent laser is encoded and modulated.

Regarding the steps of determining the operation mode of the primary emergent laser of the corresponding channel according to the detection result of the plurality of secondary emergent laser, obtaining the operation mode of the primary emergent laser of all the channels, the following should be noted.

First, the detection result of the secondary emergent laser of a certain channel determines the operation mode of the primary emergent laser of the corresponding channel only. Different operation modes can be adopted for the primary emergent lasers of the different channels during the same operation cycle. For example, during the current operation cycle, the primary emergent lasers of CH1, CH2, and CH5 adopt the long-range mode of the operation while primary emergent lasers of CH3 and CH4 adopt the near-range mode of the operation.

There are three possibilities of the operation modes of the primary emergent lasers of all the channels obtained from the LiDAR: 1) the primary emergent lasers of all the channels adopt the long-range mode of the operation to encode and modulate the emission of the primary emergent lasers of all the channels; 2) the primary emergent lasers of all the channels adopt the near-range mode of the operation. All the channels emit the primary emergent lasers at the preset reference moment; 3) the primary emergent lasers of a part of the channels adopt the long-range mode of the operation to encode and modulate the emission of the primary emergent lasers of that part of channels, while the primary emergent laser of the remaining channel adopts the near-range mode of the operation. Those remaining channels emit the primary emergent lasers at the preset reference moment.

Second, when adopting a high-voltage constant-voltage source, the drive circuit of the laser device of the LiDAR can quickly respond and adjust the emission power of the laser device. At this point, according to the detection result of the secondary emergent laser in the current detection cycle, the operation mode of the primary emergent laser of the channel corresponding to the current detection cycle can be determined. According to the detection result of the secondary emergent laser in the current detection cycle, the operation mode of the primary emergent laser is determined. Corresponding drive instructions are sent to the drive circuit. The drive circuit can quickly respond and turn on the constant voltage source to directly drive the laser device to emit the primary emergent laser with corresponding power.

However, to control input power, the LiDAR usually adopts drive circuits of the charging energy, transferring energy, and enabling energy to drive the laser device. When driving the laser device, the power source first charges the charging module and stores the electrical energy on an inductor. After charging is completed, the electrical energy stored on the inductor is transferred to an energy storage capacitor according to energy transferring instructions. Finally, the electrical energy stored on the energy storage capacitor is released to the laser device according to enabling instructions, and then the laser device emits the emergent light. Therefore, the above drive process takes some time. At the same time, after receiving an echo laser of the secondary emergent laser, the receiver outputs echo signals. A back-end output circuit amplifies, shapes, and samples the echo signals, which also takes up some time. The detection result cannot be immediately output. Therefore, to ensure a point frequency of the LiDAR, this solution adopts the detection result of the secondary emergent laser of the current detection cycle to determine the operation mode of the primary emergent laser of the next detection cycle. If the drive speed of the laser device and the processing speed of the back-end output circuit can be increased, the above detection result of the secondary emergent laser of the current detection cycle can be adopted to determine the operation mode of the primary emergent laser of the channel corresponding to the current detection cycle.

Third, the operation modes of the primary emergent laser include the near-range mode of the operation and the long-range mode of the operation. The emission power of the primary emergent laser in the near-range mode of the operation is small and less than that of the secondary emergent laser. The emission power of the primary emergent laser in the long-range mode of the operation is large and much greater than that of the secondary emergent laser. When the above drive circuits of the charging energy, transferring energy and enabling energy are adopted, the charging energy time of the primary emergent laser in the near-range mode of the operation is much less than that of the primary emergent laser in the long-range mode of the operation.

Further, according to the detection result of the plurality of secondary emergent laser of the above embodiments, determining the mode of the operation of the primary emergent laser of the corresponding channel is as follows: if the detection result of the secondary emergent laser of the channel is that the echo laser is not received or the moment of receiving the reflection laser is greater than the third moment, it is determined that the primary emergent laser of the channel adopts the long-range mode of the operation; if the detection result of the secondary emergent laser of the channel is that the moment of receiving the emission lasers is less than or equal to the third moment, it is determined that the primary emergent laser of the channel adopts the near-range mode of the operation. In the above embodiment, the third moment is the extinction moment of the leading signals when the primary emission detection cycle adopts the long-range mode.

The detection result of the secondary emergent lasers of the plurality of channels can be achieved by steps S301 to S303.

Step S301: determining whether to identify reflection signals in the echo signals, where the reflection signal is a laser of the secondary emergent laser that emits to a detection region and is reflected back.

If there is a target object within the farthest detection distance of the secondary emergent laser, the receiver of the LiDAR receives the echo laser, the echo laser includes a reflection laser and a stray light returned after the secondary emergent laser is reflected by the target object, and outputs the corresponding reflection signals and leading signals. Therefore, the echo signals output from the secondary emission cycle includes the reflection signals and the leading signals.

Step S302: if the reflection signals are not identified, the detection result is determined according to the waveform feature of the leading signals of the secondary emergent laser.

If the reflection signals are not identified, there are two situations: first, the receiver receives the reflection laser of the secondary emergent laser, but the reflection signals and the leading signals that are both output by the receiver are overlapped. The back-end output circuit cannot distinguish the reflection signals of the secondary emergent laser. Second, the target object is beyond a ranging scope. The receiver really does not receive the reflection laser of the secondary emergent laser. The receiver does not output the reflection signals but only the leading signals.

In some embodiments, according to the waveform feature of the leading signals of the secondary emergent laser, determining the detection result can be as follows: obtaining a feature difference between a waveform feature of the leading signals of the secondary emergent laser and a preset waveform feature; comparing the feature difference with a preset threshold; if an absolute value of the feature difference exceeds the preset threshold, it is determined that the moment of receiving the reflection laser of the secondary emergent laser is earlier than a fourth moment; that is, the detection result of the secondary emergent laser is that the moment of receiving the echo laser is less than the third moment. If the absolute value of the feature difference is less than or equal to the preset threshold, the detection result of the secondary emergent laser is determined that no reflection laser of the secondary emergent laser is received.

In the above embodiment, the preset waveform feature can be obtained by calibrating the leading signals of the LiDAR. By comparing the received leading signals with the waveform feature of the leading signals obtained by advance calibration, it is possible to know whether there are overlapped reflection signals.

Therefore, if a feature difference between the waveform feature of the leading signals output from the receiver and the preset waveform feature exceeds the preset threshold after the secondary emergent laser is emitted in the current detection cycle, it indicates that indistinguishable reflection signals are overlapped in the leading signals, resulting in a significant change in the waveform feature of the leading signals. It indicates that the receiver receives the reflection laser, and the moment of receiving the reflection laser is earlier than the fourth moment. When the receiving moment of the reflection laser is earlier than the fourth moment, the reflection signals and the leading signals are too close with each other and overlapped together to be indistinguishable. If the feature difference between the waveform feature of the leading signals output from the receiver and the preset waveform feature does not exceed the preset threshold value, it indicates that the received echo signals are the leading signals. There is no reflection signals. Therefore, the reflection laser is not received.

The waveform feature can be a pulse width. In some embodiments, the leading signals have a pulse width greater than a preset threshold. The waveform feature can also be an amplitude. In some embodiments, the amplitude of the leading signals is greater than a preset threshold. The waveform feature can also be a waveform area. In some embodiments, the waveform area of the leading signals is larger than a preset threshold.

The larger waveform area may be caused by changes in the amplitude and/or the pulse width.

Step S303: If the reflection signal is identified, the detection result is determined according to the moment of receiving the reflection signals.

If the back-end output circuit can identify the reflection signals, it indicates that two waveforms can be sampled in the secondary emission analysis region, and are the leading signals and the reflection signals of the secondary emergent laser, respectively. The moment of receiving the reflection laser is later than the fourth moment. The moment of receiving the reflection laser can be obtained by solving the sampled moment of the reflection signal. According to the sampling time of the reflection signals, the moment of receiving the reflection laser is obtained, thus determining the detection result of the secondary emergent laser.

When the moment of receiving the reflection laser is less than or equal to the third moment, the moment of receiving the reflection laser of the secondary emergent laser is located between the fourth moment and the third moment. The reflection signals are not overlapped with the leading signals of the secondary emergent laser, but still are overlapped with the leading signals of the primary emergent laser in the long-range mode. The target object is located within the near-field blind region of the primary emission detection cycle of the long-range mode, e.g., the near-field blind region of the primary emission detection cycle of the long-range mode is 0 to 15 m. When the moment of receiving the reflection laser is greater than the third moment, the moment of receiving the reflection laser of the secondary emergent laser is greater than the third moment. The reflection signal is not overlapped with the leading signals of the secondary emergent laser or is not overlapped with the leading signals of the primary emergent laser of the long-range mode. As a result, the target object is located in the far-field region, e.g., the target region is located in a far-field region in a range of 15 m to 200 m.

When the detection result of the secondary emergent laser is that the reflection laser is not received or the moment of receiving the reflection laser is greater than the third moment, it is determined that the primary emergent laser adopts the long-range mode of the operation to obtain the strongest detection capability. The target object or an object with low reflectivity at a longer distance is further determined. The emission power of the primary emergent laser in the long-range mode of the operation is much higher than the emission power of the secondary emergent laser. The emission power of the primary emergent laser in the long-range mode is the maximum emission power of the LiDAR, which is usually a full power. In addition, if the detection result of the secondary emergent laser shows that there is no reflection laser in the near-field region, such as a range of 2 m to 20 m, the possibility that a person is within the range can be excluded. The primary emergent laser adopts the long-range mode of the operation, which can ensure the ranging capability of the LiDAR (for example, the farthest detection distance of the LiDAR needs to reach 200 m), and also ensure the safety of human eyes, thereby avoiding emitting a high power emergent laser when a person in the near-field region.

When the moment of receiving the reflection laser is less than or equal to the third moment, the target object is located in the near-field blind region of the primary emergent laser in the long-range mode of the operation. The primary emergent laser is determined to adopt the near-range mode of the operation. To be able to accurately detect the target object at a closer distance, the emission power of the primary emergent laser is less than the emission power of the secondary emergent laser. The stray light is further reduced. A small amount of the stray light does not excite the receiver. The receiver does not output the leading signals, thus avoiding the impact of the leading signals on the near-field detection, and being able to accurately detect the target object in a range of 0 to 2 m. Therefore, the primary emergent laser adopts the near-range mode. The emission power of the primary emergent laser in the near-range mode is less than that of the secondary emergent laser. For example, the detection range of the primary emergent laser in the near-range mode is 0 to 10 m.

The primary emergent laser adopts the channel with the long-range mode of the operation to encode and modulate the emission of the primary emergent laser for the channel. Because the primary emergent laser of the long-range mode of the operation has the highest emission power, a corresponding far-primary analysis region is the longest. If each of the channels are still adopted to emit the primary emergent laser sequentially, and an emission interval is larger than the far-primary analysis region so that the crosstalk between the channels is solved, occupied time certainly exceeds the duration of the detection cycle, thus pulling down the frame rate of the system. Therefore, an encoding and modulating method is adopted to control the emission of the primary emergent laser. A second moment is obtained. The second moment is the beginning of the encoding region. The duration of the encoding region is random. After the encoding region, the channel is controlled to start far-primary charging energy. After the far-primary charging energy, far-primary transferring energy of the channel starts. After the far-primary transferring energy of the channel, the channel is controlled to start the far-primary enabling energy. The channel emits the primary emergent laser. The second moment can be initial signals of the galvanometer of the multichannel LiDAR, for example, the galvanometer outputs one clock signal by rotating every fixed angle. The second moment can also be generated by a clock module of the multichannel LiDAR, for example, the clock signals are output every fixed time interval. The second moment is a baseline. A period of delay is added before the main laser emission is emitted. The delay is the encoding region. The duration of the encoding region is a delay amount. Because the LiDAR solves a distance by calculating the time of receiving the reflection laser and the time of transmitting the emergent laser. The amount of delay can be eliminated by subtracting the receiving time and the transmitting time to obtain an accurate detection distance. The same object is detected by adjacent detection cycles. The same detection distance is obtained. The delay amount of interference light from the crosstalk of the other channel is different from the delay amount of the channel. The calculated detection distance is significantly changed, which in turn can identify the interference light, thereby achieving the effect of anti-interference. The encoding region is set to the maximum duration, which can be 200 ns for example. The duration of the encoding region can be any value within 0-200 ns.

The near-range mode of the operation has the lowest emission power of the primary emergent laser. The corresponding near-primary analysis region is the shortest. The duration of the near-primary-analysis region is a fourth preset time. The fourth preset time is less than the second preset time. As the primary emergent laser adopts the channel (the far-primary channel) in the long-range operation mode, the time of the far-primary charging energy is very long. As the primary emergent laser adopts the channel (the near-primary channel) in the near-mode of the operation, the near-primary charging energy and the near-primary analysis region occupy a very short time. When the near-primary channel completes one transceiver detection, the far-primary channels are still in the far-primary charging energy. Therefore, there is no crosstalk between the primary emission channel and the near-primary channel.

The primary emergent laser adopts the channel in the near-range mode of the operation and emits the primary emergent laser at the preset reference moment of the channel. The second moment is obtained. The channel is controlled at the second moment to start the near-primary charging energy. The near-primary transferring energy of the channel starts after the near-primary charging energy. The near-primary enabling energy starts at the preset reference moment of the channel after the near-primary transferring energy of the channel. The channel emits the primary emergent laser. The near-primary analysis region is very short. The primary emergent laser of all the near-primary channels is controlled to emit. An emission time interval is greater than the near-primary analysis region to avoid the crosstalk between the plurality of near-primary channels during the primary emission detection cycle.

However, regarding a channel, the operation mode of the primary emergent laser is continuously adjusted and changed according to the detection result of the secondary emergent laser. The primary emergent laser for the current detection cycle adopts the near-range operation mode. The primary emergent laser of the next detection cycle may be changed to the long-range mode of the operation. If each operation cycle of the multichannel LiDAR needs to identify all the near-primary channels and controls the primary emergent laser of these near-primary channels to emit sequentially at a certain time interval, the control difficulty is greatly increased. Therefore, each of the channels is preset with one reference moment. The time interval between the reference moments of the adjacent channels is a third preset time. The third preset time is greater than or equal to the fourth preset time. In this way, regarding a channel, the primary emergent laser of any detection cycle adopts the near-range mode of the operation and emits the primary emergent laser at the preset reference moment, so that the near-primary analysis region is not overlapped with other channel and causes the crosstalk. However, regarding the multichannel LiDAR, the near-primary channel only needs to control the emission of the primary emergent laser at the preset reference moment, which is convenient to simplify the control of the system.

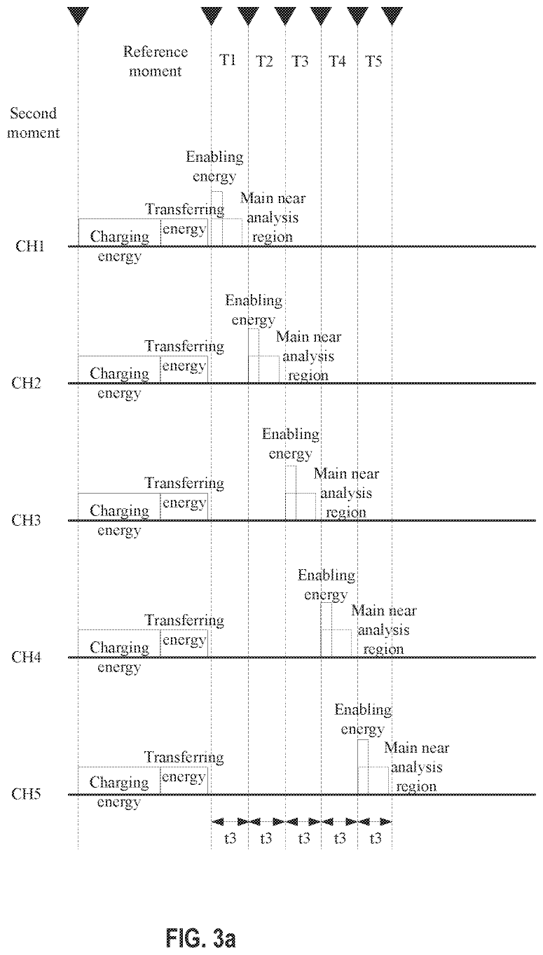

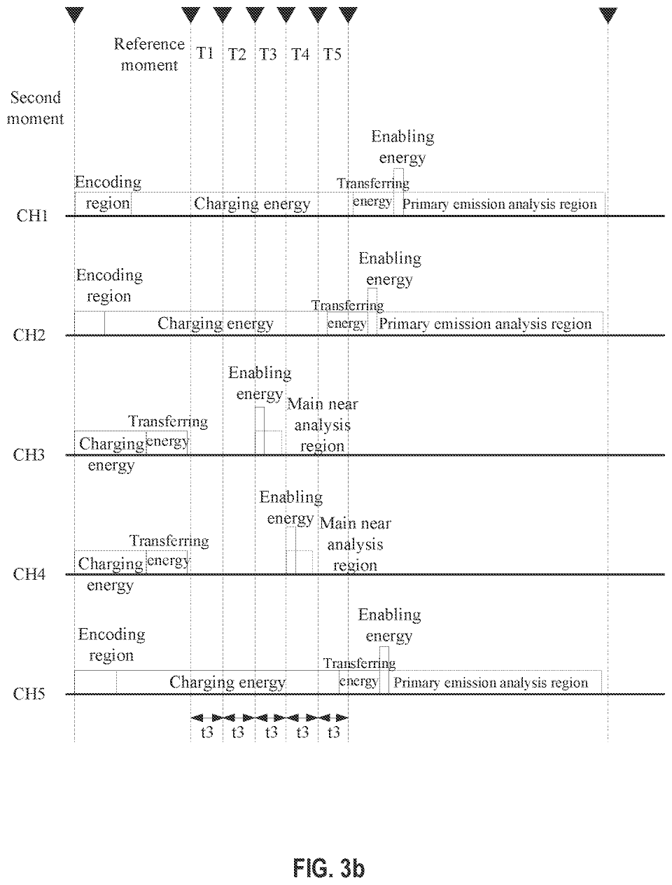

Taking as an example the above multichannel LiDAR with a total of the five channels (i.e., CH1-CH5) of CH1, CH2, CH3, CH4, and CH5, the emission control of the primary emergent laser in different operation modes is described by combining FIG. 3a with FIG. 3b.

As shown in FIG. 3a, CH1, CH2, CH3, CH4, and CH5 are all preset with the reference moments, which are a first reference moment (T1), a second reference moment (T2), a third reference moment (T3), a fourth reference moment (T4), and a fifth reference moment (T5), respectively. A time interval between the first reference moment and the second reference moment is the third preset time (indicated by t3 in the figure). A time interval between the second reference moment and the third reference moment is also the third preset time, and so on. The time interval between the fourth reference moment and the fifth reference moment is also the third preset time. If the primary emergent lasers of CH1-CH5 all adopt the near-range mode of the operation, each of the channels emits the primary emergent laser sequentially. The emission interval is greater than the duration of the near-primary analysis region. No crosstalk occurs during the five primary emission detection cycles.

Also, the total time obtained by adding the near-primary charging energy, the near-primary transferring energy, the near-primary enabling energy of the five channels and the third preset time occupied by the five channels is also less than the time of the far-primary charging energy. Therefore, there is no overlapping region between the near-primary analysis region and the far-primary analysis region. No crosstalk is generated for the primary emission detection cycles of the near-primary channel and the far-primary channel.

The primary emergent lasers of the channels CH1, CH2, and CH5 of the current operation cycle of the multichannel LiDAR adopt the long-range mode of the operation for, while the primary emergent lasers of the channels CH3 and CH4 adopt the near-range mode of the operation. These two are described as examples.

As shown in FIG. 3b, when the primary emergent lasers of the channels CH1, CH2, and CH5 adopt the long-range mode of the operation, all the three channels start to encode at the second moment of the respective detection cycles. After a delay in the encoding region, the far-primary charging energy, the far-primary transferring energy, and the far-primary enabling energy (briefly expressed in the figure using the charging energy, the transferring energy, and the enabling energy, respectively) emit the primary emergent laser. The duration of the encoding region for each of the three channels is random. The time duration of the primary emission charging energy and the primary emission transferring energy is the same for all the three channels. The moment of the far-primary enabling energy is different because of the different duration of the encoding region, i.e., the emission moment of the primary emergent laser is slightly earlier or later for the three channels. When the primary emergent lasers of the channels CH3 and CH4 adopt the near-range mode of the operation, both channels start the near-primary charging energy and the near-primary transferring energy at the second moment of the respective detection cycles. After the transferring energy is completed, channel CH3 conducts the near-primary enabling energy at the third reference moment, and emits the primary emergent laser. Channel CH4 conducts the near-primary enabling energy at the fourth reference moment, and emits the primary emergent laser.

If the primary emergent lasers of the channels CH1 and CH4 in the next operation cycle of the multichannel LiDAR adopt the long-range mode of the operation, while the primary emergent lasers of the channels CH2, CH3, and CH5 adopt the near-range mode of the operation. The channels CH1 and CH4 start to encode at the second moment of the respective detection cycles. After a delay in the encoding region, the far-primary charging energy, the far-primary transferring energy, and the far-primary enabling energy start to emit the main transmitting laser. The duration of the encoding region for the two channels is different. The channels CH2, CH3, and CH5 start the near-primary charging energy and the near-primary transferring energy at the second moment of the respective detection cycles. Channel CH2 conducts the near-primary enabling energy at the second reference moment and emits the primary emergent laser. Channel CH3 conducts the near-primary enabling energy at the third reference moment and emits the primary emergent laser. Channel CH5 conducts the near-primary enabling energy at the fifth reference moment and emits the primary emergent laser.

From the method for controlling the multichannel laser emission exemplified in FIG. 2 above, it is known that the emission of the secondary emergent lasers of the plurality of channels of the multichannel LiDAR is controlled in the time-sharing manner during the operation cycle of the multichannel LiDAR. The primary emergent laser is emitted at the preset reference moment of the channel, or the emission of the primary emergent laser is encoded and modulated according to the detection result of the secondary emergent laser of the plurality of channels. The detection cycle of each of the channels of the LiDAR includes the secondary emission cycle and the primary emission cycle. The LiDAR of the plurality of channels includes the plurality of secondary emission and primary emission cycles. The duration of the operation cycle of the LiDAR is limited by the frame rate of the system. The emission of the secondary emergent lasers of the plurality of channels is controlled with a time-sharing manner. The primary emergent laser is emitted at the preset reference moment of the channel, or the emission of the primary emergent laser is encoded and modulated. Therefore, the secondary emission and primary emission cycles of the plurality of channels can be spaced apart in time, or a reflection laser of this channel can be identified by encoding and decoding, which can prevent a crosstalk between the channels during the operation of the multichannel laser without increasing the cost.

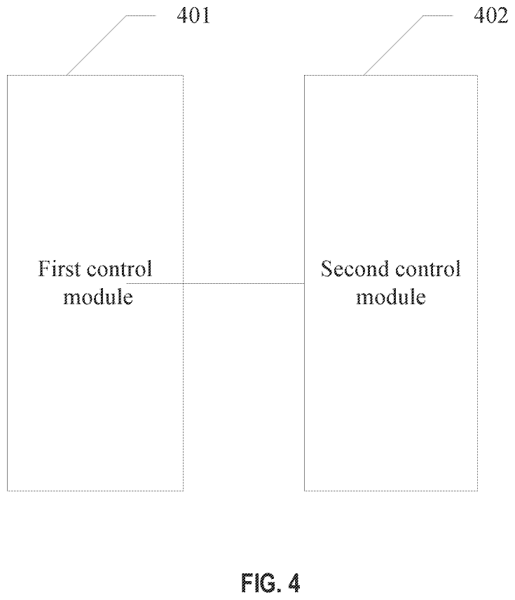

FIG. 4 is a schematic structural diagram of a control device for the laser emission of a multichannel provided in an embodiment of the present application. For ease of description, only those portions that relate to embodiments of the present application are shown. The device for controlling the multichannel laser emission exemplified in FIG. 4 includes a first control module 401 and a second control module 402.

The first control module 401 is configured to control the emission of secondary emergent lasers of the plurality of channels of the multichannel LiDAR in a time-sharing manner during the operation cycle of the multichannel LiDAR.

The second control module 402 is configured to emit a primary emergent laser at a preset reference moment of the channel or encode and modulate the emission of the primary emergent laser according to the detection result of the secondary emergent lasers of the plurality of channels.

For the device in this embodiment, how the modules implement the operations has been described in the embodiments of the method in detail, and no further elaboration is provided herein.

As can be seen from the device for controlling the multichannel laser emission exemplified in FIG. 4 above, the emission of the secondary emergent lasers of the plurality of channels of the multichannel LiDAR is controlled in a time-sharing manner during the operation cycle of the multichannel LiDAR. The primary emergent laser is emitted at the preset reference moment of the channel, or the emission of the primary emergent laser is encoded and modulated according to the detection result of the secondary emergent lasers of the plurality of channels. The detection cycle of each of the channels of the LiDAR includes a secondary emission cycle and a primary emission cycle. The LiDAR of the plurality of channels includes the plurality of secondary emission and primary emission cycles. The duration of the operation cycle of the LiDAR is limited by the frame rate of a system. The emission of the secondary emergent lasers of the plurality of channels is controlled with a time-sharing manner. The primary emergent laser is emitted at the preset reference moment of the channel, or the emission of the primary emergent laser is encoded and modulated. Therefore, the secondary emission and primary emission cycles of the plurality of channels can be spaced apart in time, or a reflection laser of this channel can be identified by encoding and decoding, which can prevent a crosstalk between the channels during the operation of the multichannel laser without increasing the cost.

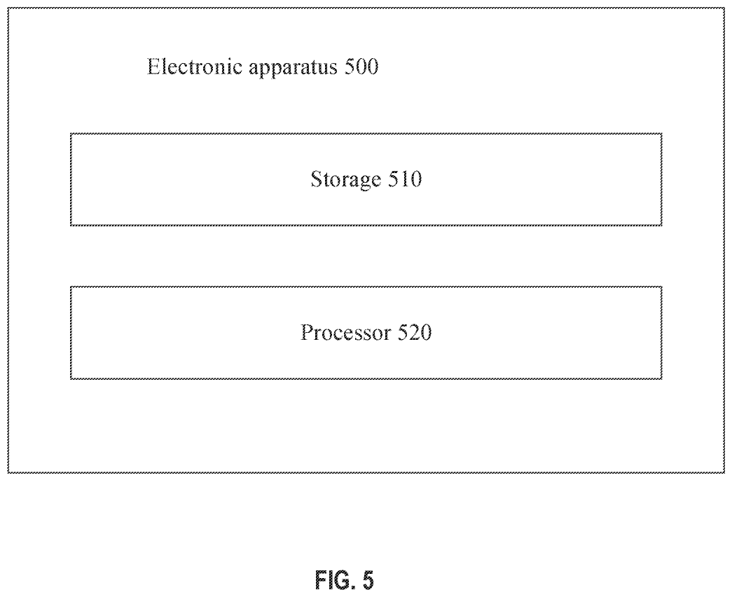

FIG. 5 is a schematic structural diagram of an electronic apparatus shown in an embodiment of the present application.

Referring to FIG. 5, the electronic apparatus 500 includes a storage 510 and a processor 520.

The processor 520 can be a Central Processing Unit (CPU) or other general-purpose processor, Digital Signal Processor (DSP), Application Specific Integrated Circuit (ASIC), Field-Programmable Gate Array (FPGA), or other programmable logic device, a discrete gate or transistor logic device, a discrete hardware component, etc. The general-purpose processor can be a microprocessor, or the processor can be any conventional processor or the like.

The storage 510 can include various types of storage units, such as a system memory, a read-only memory (ROM), and a permanent storage device. The ROM can store static data or instructions needed by the processor 520 or other modules of a computer. The permanent storage device can be a readable/writable storage device. The permanent storage device can be a non-volatile storage that does not lose stored instructions and data even if the computer is powered off. In some embodiments, the permanent storage device uses a large-capacity storage device (for example, a magnetic or optical disk, or a flash memory). In some other implementations, the permanent storage device can be a removable storage apparatus (e.g., a floppy disk, a CD-ROM drive). A system memory can be a readable/writable storage apparatus or a volatile readable/writable storage apparatus, for example, a dynamic random access memory. The system memory can store some or all of instructions and data required by the processor during running. In addition, the storage 510 can include any combination of computer-readable storage media, including various types of semiconductor memory chips (e.g., DRAM, SRAM, SDRAM, flash memory, programmable read-only memory). A disk and/or the optical disk can also be employed. In some embodiments, the storage 510 can include a readable/writable removable storage apparatus such as a compact disc (CDs), a read-only digital versatile disk (e.g., DVD-ROM, a dual-layer DVD-ROM), a read-only Blue-ray disk, an ultra-dense disk, a flash memory card (e.g., an SD card, a min SD card, a micro-SD card, etc.), a magnetic floppy disk, etc. The computer-readable storage medium does not include a carrier wave or a transient electronic signal transmitted by wireless or wire.

Executable codes are stored on the storage 510. When the executable codes are processed by the processor 520, the executable codes can cause the processor 520 to execute some or all of the methods described above.

In addition, the method according to the present application can also be implemented as a computer program or a computer program product, where the computer program or the computer program product includes computer program code instructions for executing some or all of the steps in the above method in the present application.

In some embodiments, the present application can be implemented as a computer-readable storage medium (or a non-transitory machine-readable storage medium or a machine-readable storage medium) having executable codes stored thereon (or the computer program or computer instruction codes). When executed by the processor (a server, or the like) of the electronic apparatus, the executable codes (or the computer program or the computer instruction codes) cause the processor to execute some or all of the steps in the above method in the present application.

The embodiments of the present application are described above, but the above description is exemplary other than exhaustive, and is not limited to the disclosed embodiments. Various modifications and alterations shall be evident to a person skilled in the art without departing from the scope and spirit of the described embodiments. The terms used herein are intended to optimally explain the principle of each embodiment, actual application, or improvement of technologies in the art, or help other a person skilled in the art understand the embodiments disclosed herein.

What is claimed is:

1. A control method for multichannel laser emission, comprising:
controlling emission of secondary emergent lasers of a plurality of channels of a multichannel LiDAR in a time-sharing manner during an operation cycle of the multichannel LiDAR; and
emitting a primary emergent laser at a preset reference moment of each channel or encoding and modulating emission of the primary emergent laser according to a detection result of the secondary emergent lasers of the plurality of channels.

2. The control method according to claim 1, wherein controlling the emission of the secondary emergent lasers of the plurality of channels of the multichannel LiDAR in the time-sharing manner comprises:
controlling the emission of the secondary emergent lasers of the plurality of channels by an interval of a first preset time.

3. The control method according to claim 2, wherein controlling the emission of the secondary emergent lasers of the plurality of channels by the interval of the first preset time comprises:
at a first moment, controlling each channel to start secondary emission charging energy;
starting secondary emission transferring energy of each channel after the secondary emission charging energy; and
after the secondary emission transferring energy of each channel, controlling each channel sequentially to start secondary emission enabling energy, wherein the plurality of channels emit the secondary emergent lasers, and an interval of the secondary emission enabling energy of adjacent channels is the first preset time.

4. The control method according to claim 3, further comprising:
a duration of a secondary emission analysis region of each channel being a second preset time, and the first preset time being greater than or equal to the second preset time.

5. The control method according to claim 1, wherein emitting the primary emergent laser at the preset reference moment of each channel or encoding and modulating the emission of the primary emergent laser according to the detection result of the secondary emergent lasers of the plurality of channels comprises:
determining an operation mode of the primary emergent laser of a corresponding channel according to the detection result of the secondary emergent lasers, and obtaining operation modes of the primary emergent laser of all the plurality of channels;
when the primary emergent laser of the channel adopts a near-range operation mode, emitting the primary emergent laser at the preset reference moment of the channel; and
when the primary emergent laser of the channel adopts a long-range operation mode, encoding and modulating the emission of the primary emergent laser.

6. The control method according to claim 5, wherein determining the operation mode of the primary emergent laser of the corresponding channel according to the detection result of the secondary emergent laser, and obtaining the operation modes of the primary emergent laser of all the plurality of channels comprise:
when the detection result of the secondary emergent laser of the channel is that a reflection laser is not received or a moment of receiving the reflection laser is greater than a third moment, determining that the primary emergent laser of the corresponding channel adopts the long-range operation mode; and
when the detection result of the secondary emergent laser of the channel is that a moment of receiving the reflection laser is less than or equal to the third moment, determining that the primary emergent laser of the corresponding channel adopts a near-range operation mode.

7. The control method according to claim 5, wherein encoding and modulating the emission of the primary emergent laser comprises:
obtaining a second moment, wherein the second moment is the beginning of an encoding region, and duration of the encoding region is random;
controlling the channel to start far-primary charging energy after completion of the encoding region;
starting far-primary transferring energy of the channel after completion of the far-primary charging energy; and
controlling the channel to start far-primary enabling energy after completion of the far-primary transferring energy of the channel, wherein the channel emits the primary emergent laser.

8. The control method according to claim 5, wherein emitting the primary emergent laser at the preset reference moment of the channel comprises:
obtaining a second moment, and controlling the channel to start near-primary charging energy of the channel at the second moment;
starting near-primary transferring energy of the channel after completion of the near-primary charging energy; and
starting near-primary enabling energy at a preset reference moment of the channel after completion of the near-primary transferring energy of the channel, wherein the channel emits the primary emergent laser,
wherein the channel is preconfigured with the preset reference moment, and an interval of the preset reference moment corresponding to adjacent channels is a third preset time.

9. The control method according to claim 8, further comprising:
a duration of a primary emission analysis region of the near-range operation mode being a fourth preset time, and the third preset time being greater than or equal to the fourth preset time.

10. A control device for multichannel laser emission, comprising:
a first control module, configured to control emission of secondary emergent lasers of a plurality of channels of a multichannel LiDAR in a time-sharing manner during an operation cycle of the multichannel LiDAR; and
a second control module, configured to emit a primary emergent laser at a preset reference moment of each channel or encode and modulate emission of the primary emergent laser according to a detection result of the secondary emergent lasers of the plurality of channels.

11. An electronic apparatus, comprising:
a processor; and
a storage having an executable code stored thereon, wherein when executed by the processor, the executable code causes the processor to execute a control method for multichannel laser emission, wherein the control method comprises;
controlling emission of secondary emergent lasers of a plurality of channels of a multichannel LiDAR in a time-sharing manner during an operation cycle of the multichannel LiDAR; and
emitting a primary emergent laser at a preset reference moment of each channel or encoding and modulating emission of the primary emergent laser according to a detection result of the secondary emergent lasers of the plurality of channels.
